(19) United States
(12) Patent Application Publication
(10) Pub. No.: US 2006/0151557 A1
(43) Pub. Date: Jul. 13, 2006

(54) Vehicle accessory

(76) Inventor: Vincent James Lennartz JR., Evergreen, CO (US)

Correspondence Address: ALUN L. PALMER, PATENT AGENT, 4300 PINEY CHURCH ROAD, WALDORF, MD, 20602, US

(21) Appl. No.: 11/032,007

(22) Filed: Jan. 11, 2005

(51) Int. Cl. B60R 11/00; B60R 7/00; B60R 9/00

(52) U.S. Cl. 224/544; 224/556

(57) ABSTRACT

An accessory such as a cup holder held in an existing ashtray receptacle. The ashtray is removed, and the accessory is fitted in it's place. The accessory is contoured to fit around existing obstacles, i.e. transmission lever, hand brake lever, to avoid driver or passenger encroachment. This takes into account driving safety issues i.e. gear changing of shift lever, the need in a emergency of the parking brake, spillage of hot or cold beverages because of a vehicle maneuver. Since the accessory fits into the ashtray receptacle in place of the ashtray, it is therefore installable and removable without tools. A retaining device in the form of a rubberized bumper pad on the under side of the accessory prevents it from jumping up and down when driving over rough roads and speed bumps.

### BACKGROUND OF THE INVENTION

1. Field of the Invention

The invention relates to vehicle accessories. More particularly, the invention relates to cup holders.

2. Discussion of the Background

Many modern vehicles are fitted with a number of accessories not previously included, such as cup holders, spare change holders and various small storage compartments. Modern drivers have grown used to the convenience of such accessories. However, there are still some vehicles that are not so equipped. These include not only older models, but also sports cars. The designers of the latter may consider that providing such appurtenances would detract from the sporty image or spoil the lines of the vehicle interior.

A market has therefore arisen for add-on accessories such as cup holders. For example, it is possible to purchase cup holders that fit onto the interior of the vehicle doors, such as with hooks that fit between the door trim and the window glass. These tend not to fit securely, especially when the windows are wound down, and may also intrude into the driver and passenger space. Mounting stability is particularly critical in high performance vehicles because of the mechanical stress that can occur during high speed maneuvers.

The present invention overcomes the disadvantages of prior art devices, such as lack of stability, as will be more fully described in relation to the drawings, in which like numerals refer to like features.

### SUMMARY

An accessory according to a preferred embodiment of the invention, such as a cup holder, employs the use of the existing ashtray receptacle as a means by which it is held in a fixed position. The proportion of people smoking in the general population is in decline, and increasingly many drivers no longer require an ashtray. According to the invention, the ashtray is removed, and the accessory is fitted in it's place.

An accessory according to a preferred embodiment of the invention is contoured to fit around existing obstacles such as the transmission lever or the hand brake lever, and to avoid encroachment on the driver or passenger. This takes into account driving safety issues i.e. gear changing using the shift lever or gear lever, the need in a emergency of the parking brake, and possible spillage of hot/cold beverages because of a panic maneuver of the vehicle.

Existing ashtrays are designed to be easily removed by hand in order to tip out accumulated ashes. Since the accessory according to the invention fits into the ashtray receptacle in place of the ashtray, it is therefore installable and removable without the aid of any tools.

In a preferred embodiment of the invention, a retaining device in the form of a rubberized bumper pad on the under side prevents the accessory from jumping up and down when driving over rough roads and speed bumps.

### BRIEF DESCRIPTION OF THE DRAWINGS

FIG. 1 is a top view of an accessory according to a preferred embodiment of the invention.

FIG. 2 is a bottom view of an accessory according to a preferred embodiment of the invention.

FIG. 3 is a side elevation of an accessory according to a preferred embodiment of the invention.

FIG. 4 is a first end view of an accessory according to a preferred embodiment of the invention.

FIG. 5 is a second end view of an accessory according to a preferred embodiment of the invention.

FIG. 6 is a perspective view of an accessory according to a preferred embodiment of the invention.

FIG. 7 is a further perspective view of an accessory according to a preferred embodiment of the invention.

FIG. 8 is a side view of an ashtray according to the background art.

FIG. 9 shows a plan view of an alternative embodiment of the invention.

FIG. 10 shows a perspective view of the embodiment of FIG. 9.

FIG. 11 shows a plan view of a vehicle console with an accessory according to an embodiment of the invention.

FIG. 12 shows the interior of a Chevrolet Corvette™.

FIG. 13 shows the ashtray recess shown in FIG. 12 with the flap in the open position.

### DETAILED DESCRIPTION

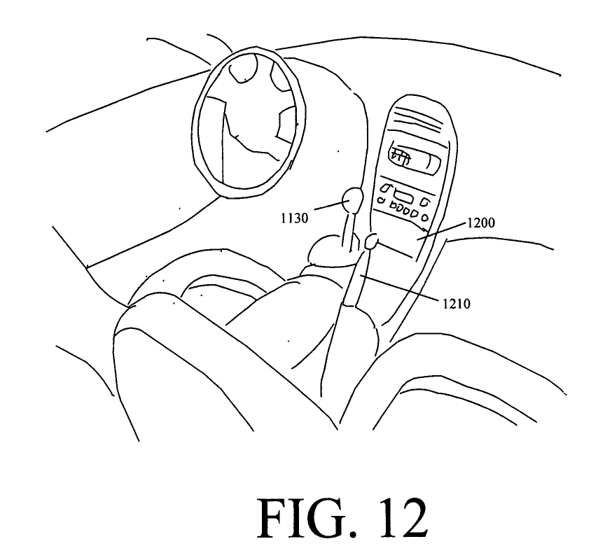

FIG. 12 shows the interior of a left-hand drive manual transmission Chevrolet Corvette™. The ashtray unit is shown at 1200, with the covering flap in the closed or down position. Note also the positions of the gear lever 1130 and the handbrake 1210. It will be appreciated by those skilled in the art that this interior view is merely exemplary, and that the invention is applicable to other makes and models of vehicle, as well as to right-hand drive vehicles and vehicles with automatic transmission.

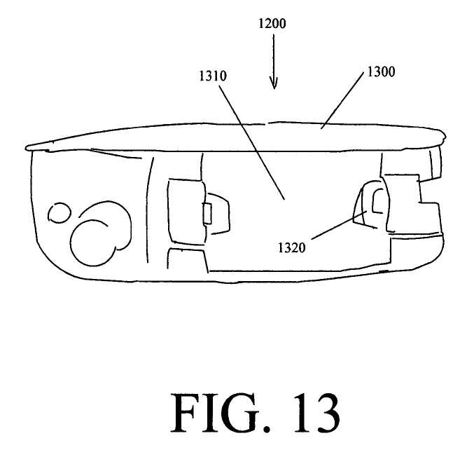

FIG. 13 shows the ashtray unit 1200 as shown in FIG. 12 with the flap 1300 in the open position and with the ashtray itself removed. Ashtray unit 1200 comprises an ashtray recess 1310 provided with clips 1320 inside thereof configured to retain an ashtray. The shape and exact mode of operation of the clips 1320 forms no part of the invention, as the ashtray unit 1200 is a part of the vehicle.

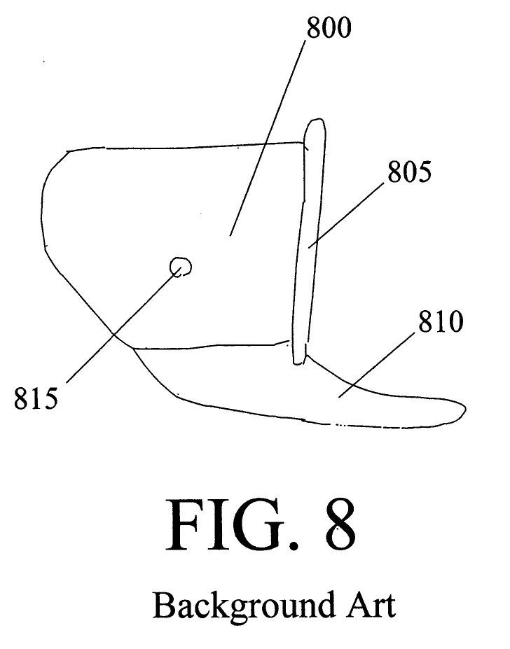

FIG. 8 is a side view of an exemplary ashtray according to the background art. Ashtray 800 typically comprises a flange 805, an opening flap 810 (shown in the open position) and a pair of opposing lugs 815 on each side, one of which can be seen from this angle. The ashtray 800 is inserted into a recess in the vehicle fascia such that the flange 805 seats onto the surface of the fascia and the lugs 815 are retained by clips in the recess in the fascia. The ashtray 800 may be withdrawn from the ashtray recess 1310 in the ashtray unit 1200 in the fascia by applying sufficient force to overcome a spring force exerted by the clips 1320, for example when the ashtray 800 is to be emptied.

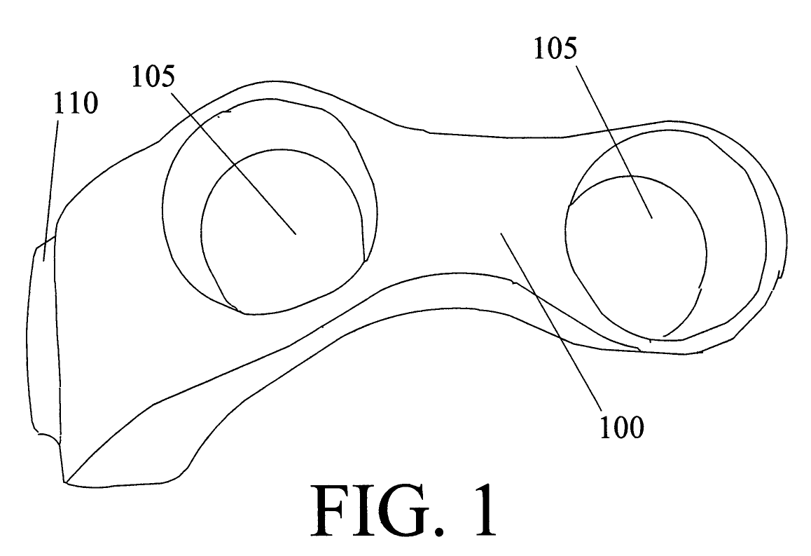

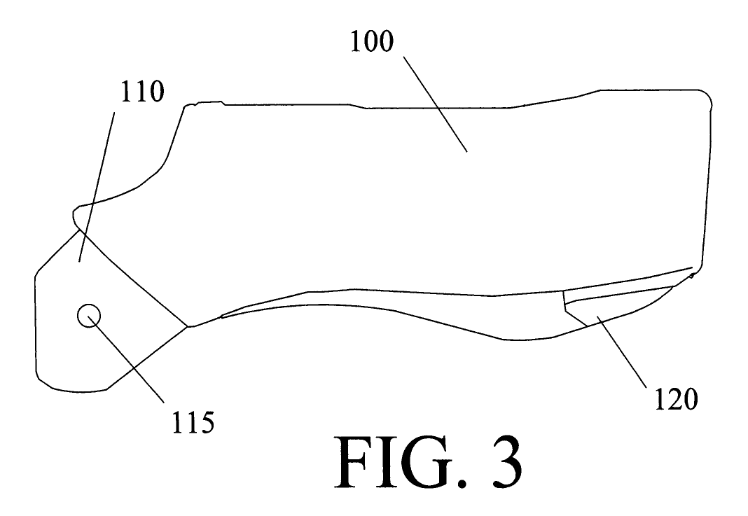

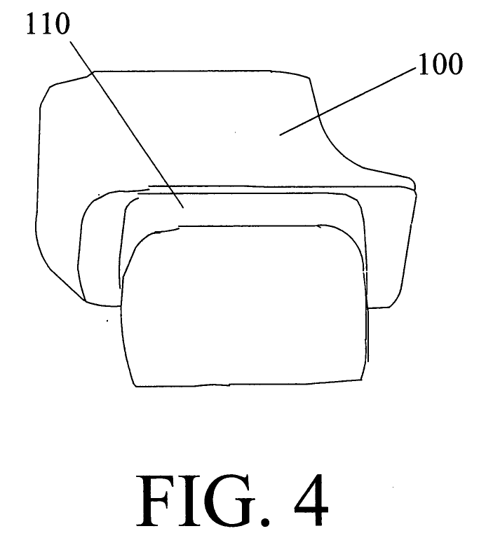

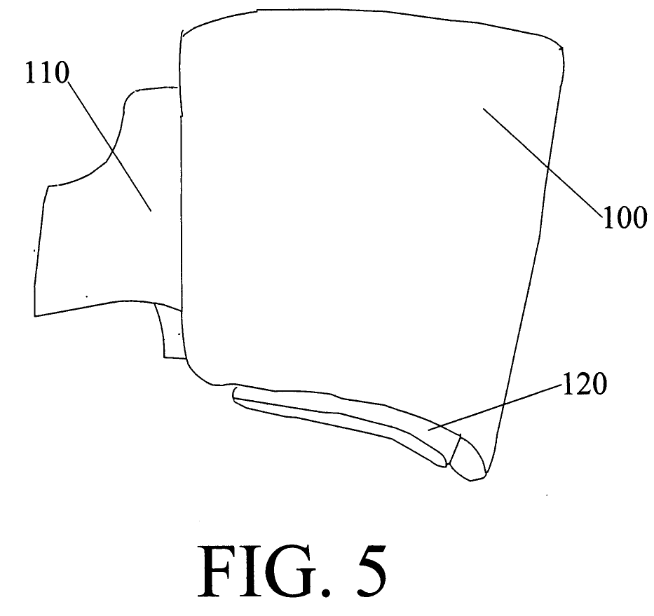

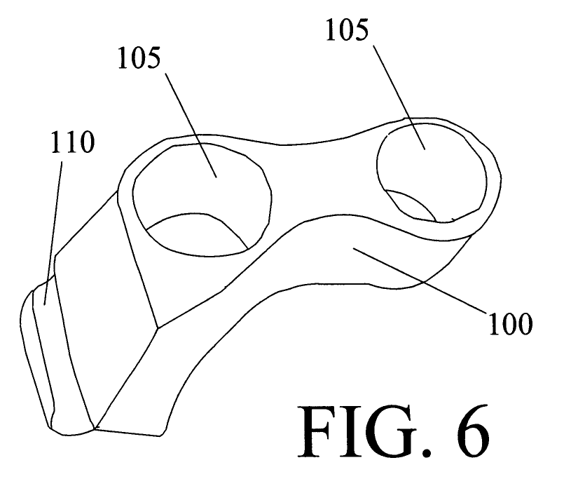

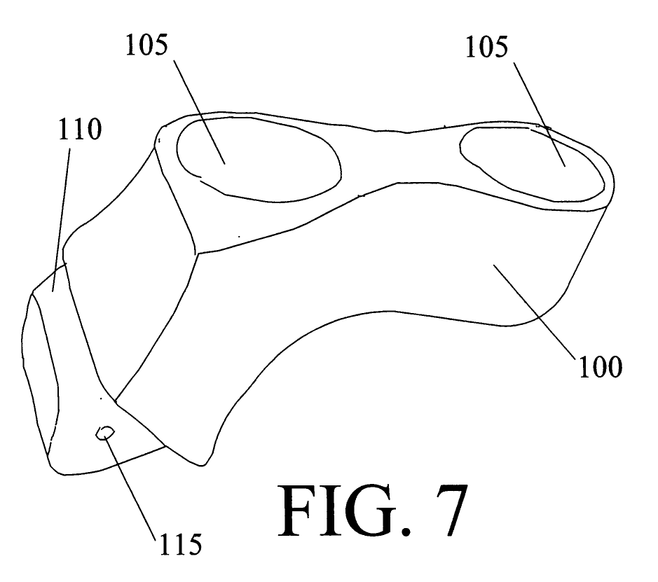

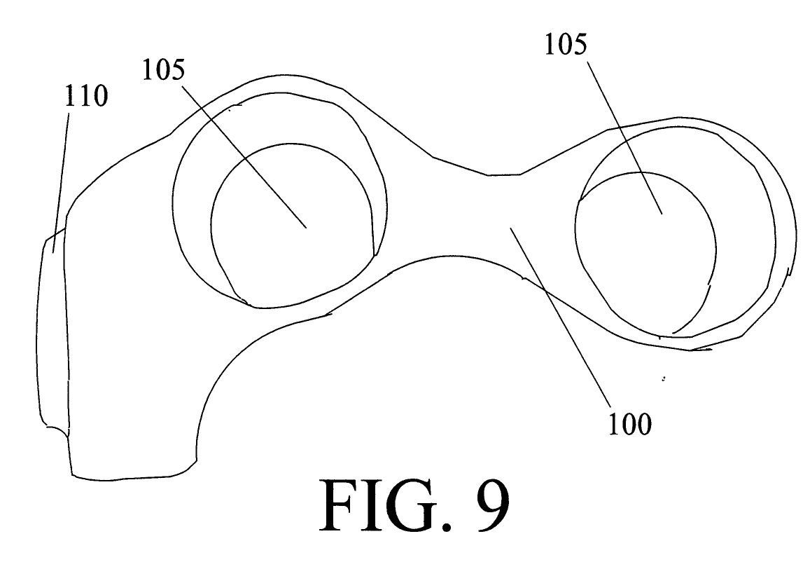

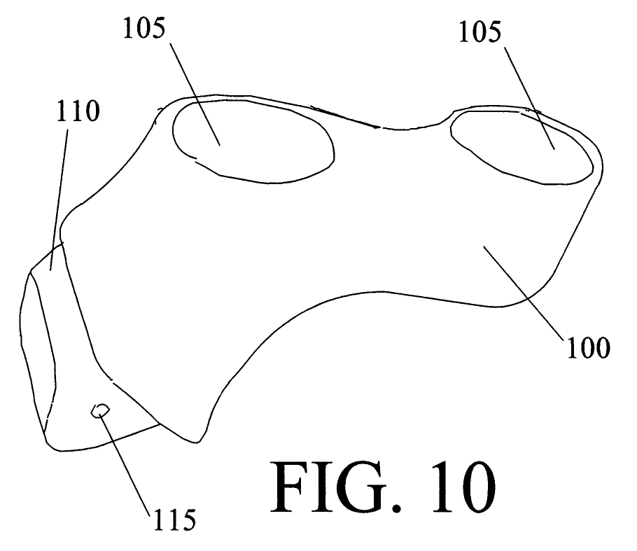

FIGS. 1 to 7 show a vehicle accessory according to a preferred embodiment of the invention, and FIGS. 9 and 10 show an alternative preferred embodiment. In these examples, the accessory 100 is a double cup holder and is provided with a pair of receptacles 105, for receiving e.g. beverage cups. It will be appreciated by those skilled in the art that a different number of receptacles may be provided, and that the receptacles 105 may be of different size and/or shape without departing from the scope of the invention. For example, receptacles may be provided for holding small change or other small items, and such receptacles may be oval, square or rectangular instead of substantially round, and may be provided with covers as appropriate. It will also be appreciated that receptacles 105 may be made adjustable by well-known means, so as to accommodate cups of various sizes. Other features might also conceivably be included in accessory 100, such as a cigar lighter, or other electrical accessories or controls.

The accessory 100 shown in the examples is shaped to avoid a centrally located shift lever 1130 in a left-hand drive vehicle, and to provide clearance for the driver's hand to change gears without, for example, spilling a beverage. For a right-hand drive vehicle, the accessory 100 would be a mirror image of that shown in the drawings. In addition, the precise shape and dimensions of the accessory 100 would vary with the make, model and year of the vehicle. The examples shown in the drawings are configured to fit a recent model Chevrolet Corvette™, but the invention is applicable to other vehicles with minor changes in shape and dimensions.

The accessory 100 in these examples is provided with a projection 110 configured to fit into the ashtray recess 1310 in the fascia or dashboard 1120. In addition, lugs 115 correspond to lugs 815 in the vehicle ashtray, so that the accessory 100 is retained by the clips 1320 provided in the dashboard recess. It will be further appreciated by those skilled in the art, that the actual method of retaining the accessory 100 is not critical to the invention, but merely needs to be compatible with the original means used to retain the vehicle ashtray. In the examples the engaging means comprise the opposed lugs 115 which retain the accessory 100, but if a single lug or a clip or clips were provided on the original ashtray, then the same type and number of engaging means could be provided on the accessory 100 without departing from the scope of the invention.

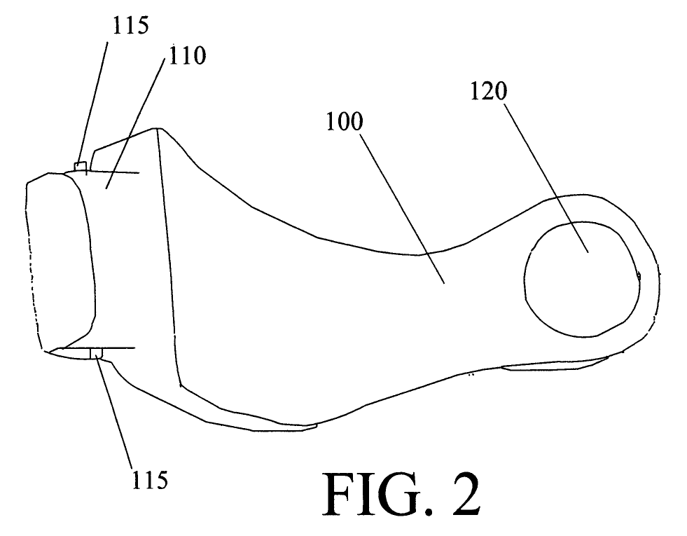

A bumper pad 120 can most clearly be seen in FIG. 2. The function of bumper pad 120 is to cushion the end of accessory 100 remote from the fascia or dashboard. This prevents unwanted noise and reduces the effects of vibration and suspension movement on the beverage cups and their contents. Bumper pad 120 may, for example, be made from sponge rubber, or any other suitable material. The shape of bumper pad 120 is shown as substantially circular, but this is merely because of the shape of the surface onto which it is affixed. Bumper pad 120 may be affixed onto accessory 100 by adhesive or by any other means.

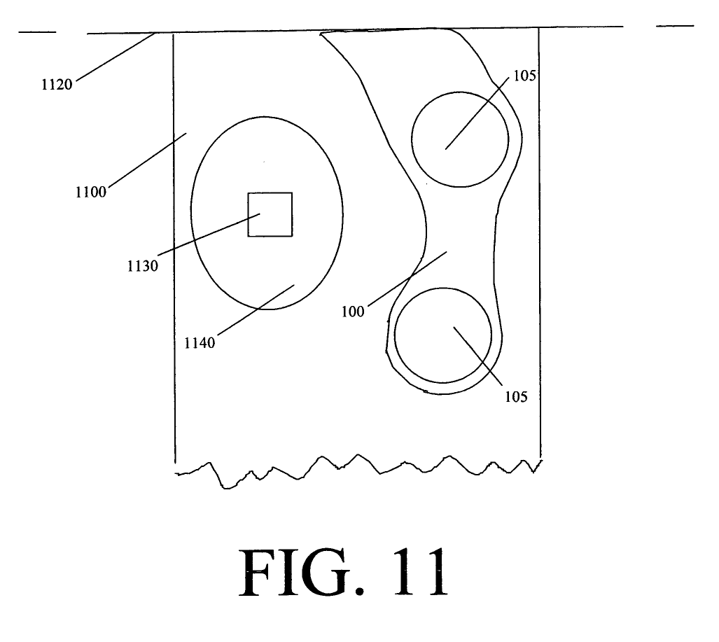

FIG. 11 shows an exemplary embodiment with the accessory 100 installed into the fascia 1120 and supported on top of the central console 1100. This shows that the contour of accessory 100 avoids the gear lever 1130 and the surround 1140 around the base of the gear lever 1130, so that the driver's hand can manipulate the gear lever 1130 without colliding with a beverage cup or cups placed in one or both of the holders 105. The driver's hand and the beverage cups are omitted for clarity.

As will readily be appreciated by those skilled in the art, numerous modifications and variations of the above embodiments of the present invention are possible without departing from the scope of the invention.

What is desired to be claimed in Letters Patent is:

1. A vehicle accessory, comprising:
a proximal end connected to a distal end; and
engaging means located at said proximal end to engage in a recess in a vehicle fascia, wherein:
said recess is configured to receive an ashtray; and
said accessory is configured to be inserted into said recess in place of said ashtray.

2. The accessory according to claim 1, wherein:
said engaging means comprise an opposed pair of lugs.

3. The accessory according to claim 1, further comprising:
retaining means configured to retain at least one item.

4. The accessory according to claim 3, wherein:
said at least one item comprises at least one beverage container.

5. The accessory according to claim 4, wherein:
said at least one item comprises two beverage containers.

6. The accessory according to claim 1, wherein:
said retaining means comprises at least one container configured to receive small objects.

7. The accessory according to claim 1, wherein:
said accessory is contoured to avoid interference with vehicle controls.

8. The accessory according to claim 1, wherein:
said accessory is provided with a bumper pad at said distal end.

9. A vehicle cup holder, comprising:
a proximal end connected to a distal end;
engaging means located at said proximal end and configured to engage in a recess in a vehicle fascia, and
retaining means configured to retain at least one beverage container.

10. The cup holder according to claim 9, wherein:
said recess is configured to receive an ashtray; and
said cup holder is configured to be inserted into said recess in place of said ashtray.

11. The cup holder according to claim 9, wherein:
said engaging means comprise an opposed pair of lugs.

12. The cup holder according to claim 9, wherein:
said cup holder is contoured to avoid interference with vehicle controls.

13. The cup holder according to claim 9, wherein:
said cup holder is provided with a bumper pad at said distal end.

14. The cup holder according to claim 9, wherein:
said retaining means is configured to receive two beverage containers.

15. The cup holder according to claim 9, further comprising:
at least one container configured to receive small objects.
